(19) United States
(12) Patent Application Publication
(10) Pub. No.: US 2024/0274080 A1
(43) Pub. Date: Aug. 15, 2024

(54) ELECTRO-OPTICAL DEVICE AND ELECTRONIC APPARATUS

(71) Applicant: SEIKO EPSON CORPORATION, Tokyo (JP)

(72) Inventors: Takehiko KUBOTA, Matsumoto-shi (JP); Hitoshi OTA, Shiojiri-shi (JP)

(73) Assignee: SEIKO EPSON CORPORATION, Tokyo (JP)

(21) Appl. No.: 18/436,935

(22) Filed: Feb. 8, 2024

(30) Foreign Application Priority Data
Feb. 9, 2023 (JP) 2023-018045

(51) Int. Cl. G09G 3/3233

(52) U.S. Cl. CPC G09G 3/3233; G09G 2300/0819; G09G 2300/0842; G09G 2310/0291; G09G 2310/08

(57) ABSTRACT

An electro-optical device includes a scanning line, a data line, a pixel circuit provided corresponding to an intersection between the scanning line and the data line and including an OLED, a DA conversion circuit that outputs, to a data signal output line, a data signal at a potential corresponding to the brightness of the OLED, a capacitance element having one end coupled to the data signal output line and the other end coupled to the data line, a capacitance element having one end coupled to the data line, and a NOT circuit that shifts a potential of the other end of the capacitance element before the data signal is output or after the data signal is output.

The present application is based on, and claims priority from JP Application Serial Number 2023-018045, filed Feb. 9, 2023, the disclosure of which is hereby incorporated by reference herein in its entirety.

### BACKGROUND

### 1. Technical Field

The present disclosure relates to an electro-optical device and an electronic apparatus.

### 2. Related Art

In recent years, various types of electro-optical devices using light-emitting elements such as organic light-emitting diode (hereinafter referred to as “OLED”) elements have been proposed. Electro-optical devices typically have a configuration in which pixel circuits including the above-mentioned light-emitting element and a drive transistor are provided corresponding to intersections between scanning lines and data lines and corresponding to pixels of an image to be displayed.

In such a configuration, when a data signal at a potential corresponding to a gradation level of a pixel is supplied to a gate node of the drive transistor, the drive transistor supplies a current corresponding to a voltage between the gate node and a source node to the light-emitting element. With this, the light-emitting element emits light at brightness corresponding to the gradation level.

A circuit that outputs a data signal has a high driving performance to quickly charge a data line. Meanwhile, in order to perform display with high quality, the potential at the gate node of the driving transistor is controlled at high accuracy to express fine gradation variations. In view of this, there has been proposed a technique of supplying a data signal to a gate node of a drive transistor with an amplification range of the data signal compressed, by outputting the data signal to a data line via a coupling capacitor (see, for example, JP-A-2013-171234).

In order to achieve a state in which a current does not flow to a light-emitting element, in other words, a black display state, a potential of the gate node of the drive transistor needs to be brought close to a potential of a source node of the drive transistor. For this purpose, a capacitance value of the coupling capacitor needs to be increased. However, in order to increase the capacitance value of the coupling capacitor, a space of a certain size needs to be secured, which makes miniaturization difficult.

### SUMMARY

In order to solve the above-mentioned problem, an electro-optical device according to one aspect of the present disclosure includes a scanning line, a first data line, a first pixel circuit provided corresponding to an intersection between the scanning line and the first data line and including a first light-emitting element configured to emit light at brightness corresponding to a potential of the first data line, an output circuit configured to output, to a first output line, a first data signal at a potential corresponding to the brightness of the first light-emitting element, a first coupling capacitor including two electrodes of which one electrode is electrically coupled to the first output line and the other electrode is electrically coupled to the first data line, and a shift circuit configured to shift a potential of the first data line before the first data signal is output or after the first data signal is output.

### BRIEF DESCRIPTION OF THE DRAWINGS

FIG. 1 is a perspective view of an electro-optical device according to a first embodiment.

FIG. 2 is a block diagram illustrating an electrical configuration of the electro-optical device.

FIG. 3 is a diagram illustrating a pixel circuit of the electro-optical device.

FIG. 4 is a timing chart illustrating an operation of the electro-optical device.

FIG. 5 is a diagram illustrating comparison of offsets in the electro-optical device.

FIG. 6 is a diagram illustrating a degree of a potential in an electro-optical device according to a comparative example.

FIG. 7 is a timing chart for illustrating an operation of an electro-optical device according to a second embodiment.

FIG. 8 is a block diagram illustrating an electrical configuration of an electro-optical device according to a third embodiment.

FIG. 9 is a block diagram illustrating an electrical configuration of an electro-optical device according to a fourth embodiment.

FIG. 10 is a block diagram illustrating an electrical configuration of an electro-optical device according to a fifth embodiment.

FIG. 11 is a block diagram illustrating an electrical configuration of an electro-optical device according to a sixth embodiment.

FIG. 12 is a diagram illustrating a pixel circuit of the electro-optical device.

FIG. 13 is a perspective view illustrating a head-mounted display using an electro-optical device.

FIG. 14 is a diagram illustrating an optical configuration of the head-mounted display.

### DESCRIPTION OF EMBODIMENTS

An electro-optical device according to embodiments is described below with reference to the accompanying drawings. Note that in each of the drawings, dimensions and scale of each part are made different from actual ones as appropriate. Further, the embodiments described below are suitable specific examples, and various technically preferable limitations are applied, but the scope of the disclosure is not limited to these embodiments unless they are specifically described in the following description as limiting the disclosure.

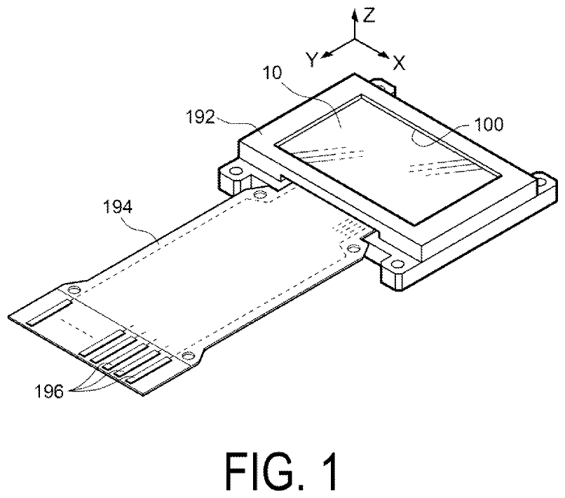

FIG. 1 is a perspective view illustrating an electro-optical device 10 according to a first embodiment. The electro-optical device 10 is a micro display panel that displays an image, for example, in a head-mounted display or the like. The electro-optical device 10 includes a pixel circuit that includes an OLED, a drive circuit that drives the pixel circuit, and the like. The pixel circuit, the drive circuit, and the like are integrated into a semiconductor substrate. The semiconductor substrate is typically a silicon substrate, but may be a different semiconductor substrate.

The electro-optical device 10 is accommodated in a frame-shaped case 192 that opens in a display region 100. The electro-optical device 10 is coupled to one end of an FPC substrate 194. Note that FPC is an abbreviation for flexible printed circuit. A plurality of terminals 196 that are coupled to a host device, which is omitted in illustration, are provided on the other end of the FPC substrate 194. When the plurality of terminals 196 are coupled to the host device, video data, synchronization signals, and the like are supplied from the host device to the electro-optical device 10 via the FPC substrate 194.

Note that in the drawings, an X direction is an extension direction of a scanning line in the electro-optical device 10, and a Y direction is an extension direction of a data line. A two-dimensional plane defined in the X direction and the Y direction is a substrate surface of a semiconductor substrate. A Z direction is perpendicular to the X direction and the Y direction, and is an emission direction of light emitted from an OLED.

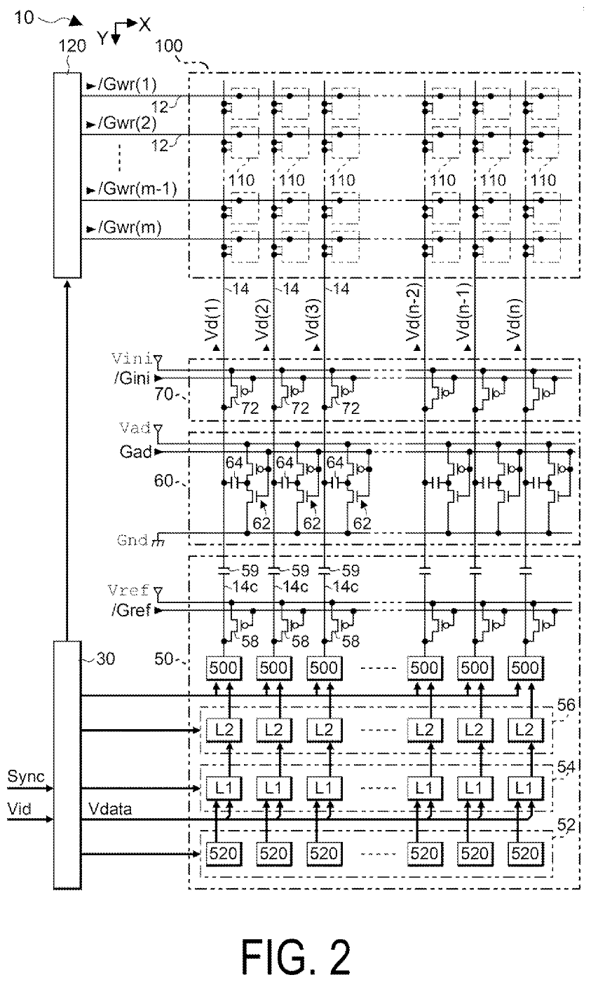

FIG. 2 is a block diagram illustrating an electrical configuration of the electro-optical device 10. As illustrated in the drawing, the electro-optical device 10 includes a control circuit 30, a data signal output circuit 50, an offset circuit 60, an initialization circuit 70, the display region 100, and a scanning line drive circuit 120.

In the display region 100, scanning lines 12 of m rows are provided in the X direction in the drawing, and data lines 14 of n columns are provided in the Y direction to be electrically insulated from each of the scanning lines 12. Note that each of m and n is an integer equal to or greater than 2.

In the display region 100, pixel circuits 110 are provided corresponding to intersections between the scanning lines 12 of the m rows and the data lines 14 of the n columns. Thus, the pixel circuits 110 are arranged in a matrix of m longitudinal rows×n horizontal columns. To distinguish the rows from each other in the array of the matrix, the rows may be referred to as first, second, third, . . . (m−1)-th, and m-th rows in order from the top in the drawing. Similarly, to distinguish the columns from each other in the matrix, the columns may be referred to as first, second, third . . . (n−1)-th, and n-th columns in order from the left in the drawing.

Note that integers from 1 to m are used to generalize and explain the scanning lines 12. Similarly, in order to generalize and explain the data lines 14, integers from 1 to n are used.

The control circuit 30 controls each portion, based on video data Vid and a synchronization signal Sync that are supplied from the high-order host device. The video data Vid designates, for example, a gradation level of a pixel in an image to be displayed by 8 bits.

The synchronization signal Sync includes a vertical synchronization signal that instructs a start of vertical scanning of the video data Vid, a horizontal synchronization signal that instructs a start of horizontal scanning, and a dot clock signal that indicates a timing of one pixel of the video data.

Pixels of an image to be displayed in the present embodiment and the pixel circuits 110 in the display region 100 correspond one-to-one with each other.

Characteristics of a luminance indicated with a gradation level in the video data Vid supplied from the host device and characteristics of brightness of the OLED included in the pixel circuit 110 do not necessarily match with each other. Thus, to make the OLED emit light at brightness corresponding to the gradation level designated by the video data Vid, the control circuit 30 up-converts 8 bits of the video data Vid into, for example, 10 bits, and outputs it as video data Vdata. Thus, the 10-bit video data Vdata is data corresponding to the gradation level designated by the video data Vid.

Note that a look-up table in which a correspondence relationship between the 8 bits of the video data Vid being an input and the 10 bits of the video data Vdata being an output is stored in advance is used in the up-conversion. Further, the control circuit 30 generates various control signals to control each portion, and details thereof are described later.

The scanning line drive circuit 120 is a circuit that outputs various signals to drive the pixel circuits 110 arranged in the m rows and the n columns for each row under the control of the control circuit 30. For example, the scanning line drive circuit 120 supplies scanning signals /Gwr(1), /Gwr(2) . . . /Gwr(m−1), /Gwr(m) to the scanning lines 12 of first, second, third . . . (m−1)-th, and m-th rows in order. To generalize, the scanning signal supplied to the scanning line 12 in the i-th row is denoted as /Gwr(i). The scanning line drive circuit 120 outputs various control signals in addition to the scanning signals /Gwr(1) to /Gwr(m), and details thereof are described later.

The data signal output circuit 50 is a circuit that outputs a voltage signal corresponding to the brightness to the pixel circuit 110 that is located in the row selected by the scanning line drive circuit 120. Specifically, the data signal output circuit 50 includes a selection circuit group 52, a first latch circuit group 54, a second latch circuit group 56, n DA conversion circuits 500, n transistors 58, and n capacitance elements 59.

The selection circuit group 52 includes selection circuits 520 corresponding one-to-one with the n columns. The first latch circuit group 54 includes first latch circuits L1 corresponding one-to-one with the n columns. The second latch circuit group 56 includes second latch circuits L2 corresponding one-to-one with the n columns. Further, the n transistors 58 and the n capacitance elements 59 correspond one-to-one with the n columns.

In other words, a group including the selection circuit 520, the first latch circuit L1, the second latch circuit L2, the DA conversion circuit 500, the transistor 58, and the capacitance element 59 is provided corresponding to each column. Here, the selection circuit 520 in the j-th column instructs the first latch circuit L1 in the j-th column to select image data in the j-th column from the video data Vdata output from the control circuit 30, and the first latch circuit L1 in the j-th column latches the video data Vdata according to the instruction. The second latch circuit L2 in the j-th column outputs the video data Vdata that i latched by the first latch circuit L1 in the j-th column, to the DA conversion circuit 500 in the j-th column during a writing period, which is described later, under the control of the control circuit 30.

The DA conversion circuit 500 in the j-th column converts the 10-bit video data Vdata that is output from the second latch circuit L2 in the j-th column, into the 10-bit video data Vdata, and outputs the analog data signal to the data line 14 via the data signal output line 14c in the j-th column and the capacitance element 59 in order. In other words, the data signal output lines 14c are provided one-to-one with the data lines 14. An output end of the DA conversion circuit 500 in the j-th column is coupled to the data signal output line 14c in the j-th column. One end of the capacitance element 59 in the j-th column is coupled to the data signal output line 14c in the j-th column. The other end of the capacitance element 59 in the j-th column is coupled to the data line 14 in the j-th column.

Note that in actuality, although not explicitly illustrated, an amplifier is provided to an output stage of the DA conversion circuit 500 in each of the columns. The amplifier subjects the analog-converted data signal to current amplification by using a power supply voltage. In other words, with regard to the data signal output line 14c in the j-th column, an analog data signal that is converted by the DA conversion circuit 500 in the j-th column is amplified by the amplifier in the j-th column, and is supplied to the data signal output line 14c.

A source node of the transistor 58 corresponding to the j-th column is coupled to a power supplying line at a potential Vref, and a drain node of the transistor 58 is coupled to the data signal output line 14c in the j-th column. Further, a control signal /Gref by the control circuit 30 is supplied to a gate node of the transistor 58 in each of the columns.

The offset circuit 60 is an assembly of pairs of NOT circuits 62 and capacitance elements 64, which are provided one-to-one with the data lines 14. Of the power supply voltage in the NOT circuit 62 in each of the columns, a high-level potential is a potential Vad, and a low-level potential is a potential Gnd being a reference of a voltage of zero. Further, a control signal Gad is supplied commonly to an input end of the NOT circuit 62 in each of the columns. An output end of the NOT circuit 62 in the j-th column is coupled to one end of the capacitance element 64 in the j-th column, and the other end of the capacitance element 64 in the j-th column is coupled to the data line 14 in the j-th column.

The initialization circuit 70 is an assembly of transistors 72 provided one-to-one with the data lines 14. A source node of the transistor 72 corresponding to the j-th column is coupled to a power supplying line at a potential Vini, and a drain node of the transistor 72 is coupled to the data line 14 in the j-th column. Further, a control signal/Gini by the control circuit 30 is supplied commonly to a gate node of the transistor 72 in each of the columns.

In the drawings, potentials of the data lines 14 in the first, second . . . (n−1)-th, and n-th columns are referred to as Vd(1), Vd(2) . . . Vd(n−1), and Vd(n) in order. To generalize, a potential of the data line 14 in the j-th column is denoted as Vd(j).

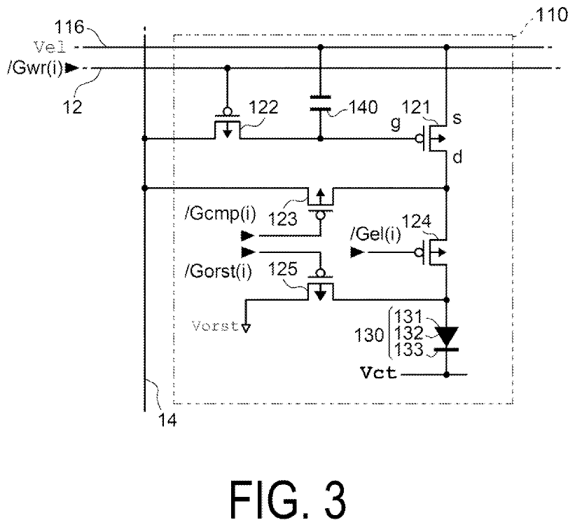

FIG. 3 is a circuit diagram illustrating the pixel circuit 110. The pixel circuits 110 arranged in the m rows and the n columns are electrically identical to each other. Therefore, the pixel circuit 110 is described with one pixel circuit 110 located in the i-th row and the j-th column as a representative.

As illustrated in the drawing, the pixel circuit 110 includes an OLED 130, p-type transistors 121 to 125, and a capacitance element 140. The transistors 121 to 125 are a MOS type, for example. Note that MOS is an abbreviation for metal-oxide-semiconductor field-effect transistor.

Further, in addition to the scanning signal /Gwr(i), control signals /Gel(i), /Gcmp(i), and /Gorst(i) are supplied from the scanning line drive circuit 120 to the pixel circuit 110 in the i-th row.

The control signal /Gel(i) is a representation to generalize the control signals /Gel(1), /Gel(2) . . . /Gel(m−1), and /Gel(m) that are supplied in order corresponding to the first, second . . . (m−1)-th, and m-th rows. Similarly, the control signal /Gcmp(i) is a representation to generalize the control signals /Gcmp(1), /Gcmp(2) . . . /Gcmp(m−1), and /Gcmp(m) that are supplied in order corresponding to the first, second . . . (m−1)-th, and m-th rows. Similarly, the control signal /Gorst(i) is also a representation to generalize the control signals /Gorst(1), /Gorst(2) . . . /Gorst(m−1), and /Gorst(m) that are supplied in order corresponding to the first, second . . . (m−1)-th, and m-th rows.

The OLED 130 is a display element in which a light emission function layer 132 is interposed between a pixel electrode 131 and a common electrode 133. The pixel electrode 131 serves as an anode, and the common electrode 133 functions as a cathode. Note that the common electrode 133 has a light-transmitting property. When a current flows from the anode to the cathode, holes injected from the anode and electrons injected from the cathode are recombined in the light emission function layer 132 to generate excitons, and white light is generated in the OLED 130.

In a case of color display, the generated white light resonates in an optical resonator configured by, for example, a reflective layer and a semi-reflective and semi-transmissive layer, which are omitted in illustration, and is emitted at a resonance wavelength that is set corresponding to any color of R (red), G (green), and B (blue). A color filter corresponding to the color is provided on the emission side of the light from the optical resonator. Thus, the emitted light from the OLED 130 is visually recognized by an observer through coloration by the optical resonator and the color filter in order. Note that the optical resonator is omitted in illustration. Further, when the electro-optical device 10 displays a monochrome image with brightness variations, the above-mentioned color filter is omitted.

In the transistor 121 of the pixel circuit 110 in the i-th row and the j-th column, a gate node g is coupled to a drain node of the transistor 122, a source node s is coupled to a power supplying line 116 to which the potential Vel is supplied, and a drain node d is coupled to a source node of the transistor 123 and a source node of the transistor 124. In the capacitance element 140, one end is coupled to the gate g of the transistor 121, and the other end is coupled to the power supplying line 116. Thus, the capacitance element 140 maintains the voltage between the gate node g and the source node s of the transistor 121.

Note that the other end of the capacitance element 140 may be coupled to a power supplying line other than the power supplying line 116 as long as the potential is maintained substantially constant. Further, the potential Vel is used as a high-level potential of the power supply voltage.

In the present embodiment, for example, a so-called MOS capacitor formed by interposing a gate insulating layer of a transistor between a semiconductor layer (a lower electrode) and a gate electrode layer (an upper electrode) of the transistor is used as the capacitance element 140. Note that as the capacitance element 140, a parasitic capacitor of the gate node g of the transistor 121 may be used, and a so-called metal capacitor formed by interposing an insulating layer with mutually different conductive layers in a semiconductor substrate may be used.

In the transistor 122 of the pixel circuit 110 in the i-th row and the j-th column, a gate node is coupled to the scanning line 12 in the i-th row, and a source node is coupled to the data line 14 in the j-th column. In the transistor 123 of the pixel circuit 110 in the i-th row and the j-th column, the control signal /Gcmp(i) is supplied to a gate node, and a drain node is coupled to the data line 14 in the j-th column. In the transistor 124 of the pixel circuit 110 in the i-th row and the j-th column, the control signal /Gel(i) is supplied to a gate node, and a drain node is coupled to the pixel electrode 131 being an anode of the OLED 130 and a drain node of the transistor 125.

In the transistor 125 of the pixel circuit 110 in the i-th row and the j-th column, the control signal /Gorst(i) is supplied to a gate node, and a source node is coupled to the power supplying line being a power source wiring line to which a potential Vorst is supplied.

For example, the potential Vorst is a low-level potential close to the potential Gnd or the potential Gnd. Specifically, the potential Vorst is such a potential that a current does not flow to the OLED 130 when power is supplied to the pixel electrode 131 in the OLED 130. A potential Vct is supplied to the common electrode 133 that functions as a cathode of the OLED 130.

Note that in the present description, “electrically coupled” or simply “coupled” means direct or indirect coupling or binding between two or more elements, and for example, includes a case in which two or more elements are not directly coupled to each other in a semiconductor substrate, but are bonded to each other via a different wiring line layer and a contact hole.

Next, an operation of the electro-optical device 10 is described.

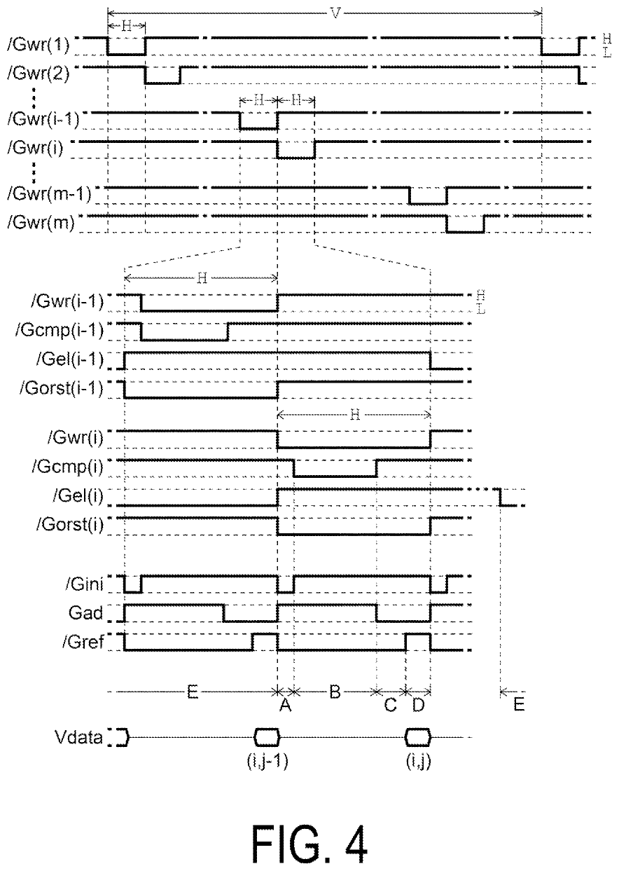

FIG. 4 is a timing chart for describing an operation of the electro-optical device. In the electro-optical device 10, the scanning lines 12 of m rows are scanned one by one in the order of first, second, third . . . m-th rows during a period of a frame (V). Specifically, as illustrated in the drawing, the scanning signals /Gwr(1), /Gwr(2) . . . /Gwr(m−1), and /Gwr (m) successively and exclusively reach an L level for each horizontal scanning period (H) by the scanning line drive circuit 120.

In the present description, the period of one frame (V) refers to a period required to display one frame of an image designated by the video data Vid. In a case in which a length of the period of one frame (V) is the same as a vertical synchronization period, for example, when a frequency of a vertical synchronization signal included in the synchronization signal Sync is 60 Hz, it is 16.7 milliseconds which corresponds to one cycle of the vertical synchronization signal. Further, the horizontal scanning period (H) is a period obtained by subtracting a vertical blanking period from one frame (V) period and dividing the resultant by m. In short, the horizontal scanning period (H) is a time interval during which the scanning signals /Gwr(1) to /Gwr(m) are at the L level in order.

In the electro-optical device 10 according to the present embodiment, a single horizontal scanning period (H) can be divided into four periods including an initialization period (A), a compensation period (B), an offset period (C), and a writing period (D) in chronological order. Further, as an operation of the pixel circuit 110, a light-emission period (E) is further added separately from the four periods described above.

In the initialization period (A) in the horizontal scanning period (H), the control signal /Gini is at the L level, the control signal Gad is at the H level, and the control signal /Gref is at the L level. In the compensation period (B), the control signal /Gini is changed to the H level, the control signal Gad is maintained at the H level, and the control signal /Gref is maintained at the L level. In the offset period (C), the control signal /Gini is maintained at the H level, the control signal Gad is changed to the L level, and the control signal /Gref is maintained at the L level. In the writing period (D), the control signal/Gini is maintained at the H level, the control signal Gad is maintained at the L level, and the control signal/Gref is changed to the H level.

An operation in the horizontal scanning period (H) is described with reference to the i-th row as an example. Further, the pixel circuit 110 is described with reference to the pixel circuit 110 in the i-th row and the j-th column as an example.

In the horizontal scanning period (H) for the i-th row, when the scanning signal /Gwr(i) is changed to the L level, the initialization period (A) for the i-th row is started. The initialization period (A) is a period for resetting a voltage or an electric charge remaining in each portion in the horizontal scanning period (H) for the (i−1) row.

In the initialization period (A) for the i-th row, the scanning signal /Gwr(i) is at the L level, the control signal /Gcmp(i) is at the H level, the control signal /Gel(i) is at the H level, the control signal /Gorst(i) is at the L level.

Thus, in the pixel circuit 110 in the i-th row, the transistor 124 is in an off state, and the transistor 125 is in an on state. Thus, the pixel electrode 131 being the anode of the OLED 130 is at the potential Vorst. Thus, the OLED 130 is turned off, and the pixel electrode 131 is reset to the potential Vorst. Note that the pixel electrode 131 is reset to eliminate an influence of the voltage applied during the immediately preceding light-emission period because the OLED 130 has parasitic capacitance.

Further, in the initialization period (A) for the i-th row, the transistor 72 in each of the columns is in the on state, and hence the data line 14 in each of the columns is at the potential Vini. In the initialization period (A) for the i-th row, in the pixel circuit 110 in the i-th row, the transistor 122 is in the on state, and hence the potential Vini of the data line 14 arrives at the gate node g of the transistor 121 of the pixel circuit 110. However, the transistor 124 of the pixel circuit 110 is in the off state, and hence a current does not flow from the source node to the drain node of the transistor 121.

In the initialization period (A) for the i-th row, the transistor 58 in each of the columns is in the on state, and hence the data signal output line 14c in each of the columns is at the potential Vref. In the initialization period (A) for the i-th row, the data line 14 in each of the columns is at the potential Vini, and hence the capacitance element 59 in each of the columns is charged with a voltage (Vini−Vref). In the initialization period (A) for the i-th row, an output end of the NOT circuit 62 in each of the columns, in other words, one end of the capacitance element 64 in each of the columns is at the potential Gnd, and hence the capacitance element 64 in each of the columns is charged with a voltage (Vini−Gnd).

After the initialization period (A) is terminated, the compensation period (B) is started. The compensation period (B) is a period for converging the gate node g of each of the transistors 121 to a threshold equivalent voltage, which is equivalent to a threshold voltage of the transistor 121, in the n pixel circuits 110 located in the i-th row.

In the compensation period (B) for the i-th row, the scanning signal /Gwr(i) is maintained at the L level, the control signal /Gcmp(i) is changed to the L level, the control signal /Gel(i) is maintained at the H level, and the control signal /Gorst(i) is maintained at the L level. Further, in the compensation period (B) for the i-th row, the transistor 72 in each of the columns is changed to the off state.

In the pixel circuit 110 in the i-th row, when the transistor 122 is in the on state, the gate node g of the transistor 121 is at the potential Vini. In a state in which the gate node g is at the potential Vini, the transistor 123 is in the on state. Thus, the transistor 121 is in a diode coupling state. Therefore, the voltage between the gate node g and the source node s of the transistor 121 is converged to a threshold voltage Vth (a close voltage) of the transistor 121. In other words, the potentials of the gate node g of the transistor 121 and the data line 14 are converged to the threshold equivalent voltage.

In the compensation period (B) for the i-th row, the transistor 58 in each of the columns is maintained in the on state. Thus, the data signal output line 14c in each of the columns is maintained at the potential Vref. In the compensation period (B) for the i-th row, the data line 14 in each of the columns is converted to the threshold equivalent voltage. Thus, the capacitance element 59 in each of the columns is charged in a state in which one end is at the potential Vref and the other is at a threshold convergence potential.

In the present embodiment, after the compensation period (B) is terminated, the offset period (C) is started. The offset period (C) is a period for offsetting (shifting) the potential of the gate node g of the transistor 121 by a predetermined potential.

In the offset period (C) for the i-th row, the scanning signal /Gwr(i) is maintained at the L level, the control signal /Gcmp(i) is changed to the H level, the control signal /Gel(i) is maintained at the H level, and the control signal /Gorst(i) is maintained at the L level.

Further, in the offset period (C) for the i-th row, the transistor 58 in each of the columns is maintained in the on state, the transistor 72 in each of the columns is maintained in the off state, and the control signal Gad is inverted to the L level. Thus, at one end of the capacitance element in each of the columns, the potential is elevated from the potential Gnd to the potential Vad. Due to this potential elevation, the potential of the data line 14 is elevated via the capacitance element 64. In the offset period (C) for the i-th row, in the pixel circuit 110 in the i-th row, the transistor 122 is in the on state. Thus, when the potential of the data line 14 is elevated, the potential of the gate node g of the transistor 121 is also elevated in the pixel circuit 110 in the i-th row.

A potential change amount of the data line 14 and the gate node g in the offset period is a value obtained by multiplying a potential change amount at one end of the capacitance element 64 by a ratio of a capacitance value of the capacitance element 64 to a “composite capacitance value”. The “composite capacitance value” referred herein is a capacitance value of a composite capacitance of the parasitic capacitances of the capacitance elements 59, 64 and 140 and the data line 14. Note that when the capacitance value of the capacitance element 140 is sufficiently smaller than the other capacitance values, the capacitance value is negligible.

In the present embodiment, when the offset period (C) is terminated, the writing period (D) is started. The writing period (D) is a period for applying a voltage corresponding to the brightness to the gate node g of each of the transistors 121 in the pixel circuits 110 located in the i-th row and the n columns.

In the writing period (D) for the i-th row, the scanning signal /Gwr(i) is maintained at the L level, the control signal /Gcmp(i) is maintained at the H level, the control signal /Gel(i) is maintained at the H level, and the control signal /Gorst(i) is maintained at the L level. Thus, in the pixel circuit 110 in the i-th row, the on state or the off state of the transistors 122 to 125 is not changed from the offset period (C).

However, in the writing period (D), the control signal /Gref is inverted to the H level, and hence the transistor 58 in each of the columns is changed to the off state. Further, the 10-bit video data Vdata corresponding to the i-th row and the column is supplied to the DA conversion circuit 500 in each of the columns. Thus, the DA conversion circuit 500 outputs, to the data signal output line 14c, a data signal at a potential corresponding to a brightness level corresponding to the i-th row and the column.

At one end of the capacitance element 59 in each of the columns, the potential is elevated from the potential Vref to the potential of the data signal. This potential elevation arrives at the gate node g of the transistor 121 via the capacitance element 59, the data line 14, and the transistor 122 in order.

A potential change amount of the gate node g in the writing period is a value obtained by multiplying an elevated potential amount at one end of the capacitance element 59 by a ratio of the capacitance value of the capacitance element 59 to the “composite capacitance value”.

When the scanning signal /Gwr(i) is changed to the H level, the writing period (D) for the i-th row is terminated. When the scanning signal /Gwr(i) is at the H level, the transistor 122 is in the off state in the pixel circuit 110 in the i-th row and the j-th column. A voltage difference between the potential of the gate node g and the potential Vel is maintained by the capacitance element 140.

After the writing period (D) is terminated, and one horizontal scanning period elapses, for example, the light-emission period (E) is started. The light-emission period (E) is a period for causing a current corresponding to the potential of the gate node g, which is maintained in the writing period (D), to flow to the OLED 130 and emitting light.

Before the light-emission period (E) for the i-th row, the control signal /Gorst(i) is at the H level. Thus, the transistor 125 is in the off state. Further, when the light-emission period (E) for the i-th row is started, the control signal /Gel(i) is inverted to the L level. Thus, the transistor 124 is in the on state. Thus, the transistor 121 causes a current corresponding to the potential of the gate node g, which is maintained by the capacitance element 140, to flow to the OLED 130. Thus, the OLED 130 emits light in an optical state corresponding to the current, in other words, at brightness corresponding to the current. The potential of the gate node g that is maintained by the capacitance element 140 is the potential of the data line 14 that is supplied via the transistor 122. In other words, the OLED 130 emits light at brightness corresponding to the potential of the data line 14.

Note that FIG. 4 is an example in which the light-emission period (E) is continuously performed. However, a period in which the control signal /Gel(i) is at the L level may be intermittent, or may be adjusted in accordance with brightness adjustment. Further, as the level of the control signal /Gel(i) in the light-emission period (E), an intermediate level between the H level and the L level may be used.

In the horizontal scanning period (H) for the i-th row, a similar operation is performed for the pixel circuit 110 in the first to n columns. Further, in FIG. 4, description is made on the operation in the horizontal scanning period (H) while focusing on the horizontal scanning period (H) for the i-th row. A similar operation is performed sequentially in the horizontal scanning period (H) for the first, second, third . . . m-th rows.

The potential of the gate node g of the pixel circuit 110 in the i-th row and the j-th column is a potential obtained by elevating the threshold equivalent voltage in the compensation period (B) by the potential change amount in the offset period (C) and then changing the resultant potential in accordance with the gradation level of the i-th row and the j-th column in the writing period (D). The other pixel circuits 110 perform a similar operation. Thus, in the embodiment, a current corresponding to the gradation level flows to the OLED 130 in a state in which the threshold value of the transistor 121 is compensated in all the pixel circuits 110 arranged in the m rows and the n columns. Therefore, in the present embodiment, brightness variations are reduced. As a result, high-quality display can be achieved.

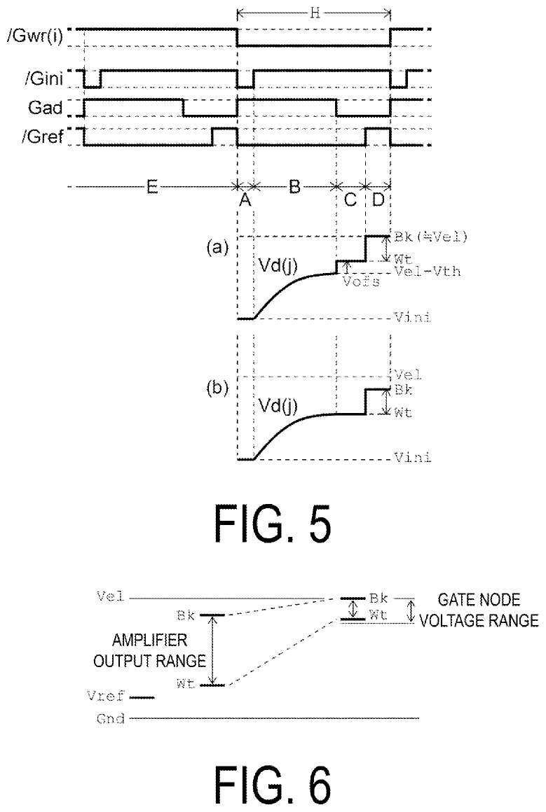

In the embodiment, in the horizontal scanning period (H) for the i-th row, the potential Vd(j) of the data line 14 in the j-th column is as illustrated in FIG. 5A. Specifically, a potential V(j) is the potential Vini in the initialization period (A), is converged to the threshold equivalent voltage (Vel−Vth) at the final stage of the compensation period (B), and is elevated from the threshold equivalent voltage by the potential change amount in the offset period (C). Note that when the potential change amount is denoted with Vofs for the sake of convenience, the potential that is offset in the offset period (C) can be denoted with (Vel−Vth+Vofs). In the writing period (D), the potential V(j) is changed from the potential (Vel−Vth+Vofs) to a range from a potential Vwt equivalent to white to a potential Vbk equivalent to black, in other words, to a potential corresponding to the gradation level.

Note that the potential Vbk equivalent to black is a potential corresponding to the lowest gradation level and the potential Vwt equivalent to white is a potential corresponding to the highest gradation level. Further, in the present embodiment, in the horizontal scanning period (H) for the i-th row, the scanning signal /Gwr(i) is at the L level. Thus, in the pixel circuit 110 in the i-th row, the transistor 122 is in the on state. Thus, in the horizontal scanning period (H) for the i-th row, the potential Vd(j) of the data line 14 is equal to a potential of the gate node g of the pixel circuit 110 in the i-th row and the j-th column.

Here, for the sake of convenience of the description, a comparative example with respect to the embodiment is described. A configuration of the comparative example is a configuration in which the offset circuit 60 is not included and the offset period (C) is not present. Thus, in the comparative example, in the horizontal scanning period (H) for the i-th row, the potential Vd(j) of the data line 14 in the j-th column is as illustrated in FIG. 5B. Specifically, the potential V(j) is the potential Vini in the initialization period (A), is converged to the threshold equivalent voltage (Vel−Vth) at the final stage of the compensation period (B), and is changed from the potential (Vel−Vth) to the range from the potential Vwt equivalent to white to the potential Vbk equivalent to black in the writing period (D).

In the comparative example, the potential equivalent to black is lower than that in the embodiment. Thus, a fine current flows to the OLED 130 to emit light, and the lowest gradation is expressed brightly. As a result, a contrast ratio is reduced.

In order to increase the potential Vbk equivalent to black to the level of the potential Vel in the writing period (D) without offset as in the comparative example, the potential Vref needs to be reduced, and the black-equivalent potential output from the amplifier at the output stage of the DA conversion circuit 500 needs to be higher at the same time, as illustrated in FIG. 6. In order to achieve this, the capacitance value of the capacitance element 59 needs to be designed so that, in the writing period (D), the black-equivalent potential is equivalent to the level of the potential Vel on arrival at the gate node g via the capacitance element 59 being a coupling capacitor and the data line 14 in order.

The amplifier at the output stage of the DA conversion circuit 500 is driven by a power supply voltage (Vel−Gnd). Thus, the range of the output voltage of the amplifier is narrower than that of the power supply voltage. When, as per the design described above, the capacitance value of the capacitance element 59 is designed so that the highest potential (black-equivalent potential) output from the amplifier is equivalent to the level of the potential Vel on arrival at the gate node g, the lowest potential (white-equivalent potential) output from the amplifier may be increased more than required on arrival at the gate node g.

Further, when the capacitance value of the capacitance element 59 is designed so that the black-equivalent potential is equivalent to the level of the potential Vel, a large capacitance value is required for the capacitance element 59. The capacitance element 59 is provided to each of the data lines 14. Thus, when a large capacitance value is required for the capacitance element 59, a larger area is required. This not only is a factor inhibiting the narrow pitch of the data lines 14 but also leads to the increase in chip size.

In view of this, in the present embodiment, as illustrated in FIG. 5A, the threshold equivalent voltage (Vel−Vth) is increased by the potential change amount Vofs in the offset period (C), and the black-equivalent potential being the highest potential of the amplifier arrives at the gate node g via the capacitance element 59 and the data line 14 in order in the writing period (D). Therefore, according to the present embodiment, there is no need to design the capacitance value of the capacitance element 59 so that the black-equivalent potential is equivalent to the level of the potential Vel. Thus, the narrow pitch of the data lines 14 (miniaturization) can easily be achieved, and the increase in chip size can be avoided.

In the first embodiment, in the horizontal scanning period (H) for each of the rows, the offset period (C) is followed by the writing period (D). The order may be switched. In view of this, description is made on a second embodiment in which the writing period (D) is performed and then the offset period (C) is performed.

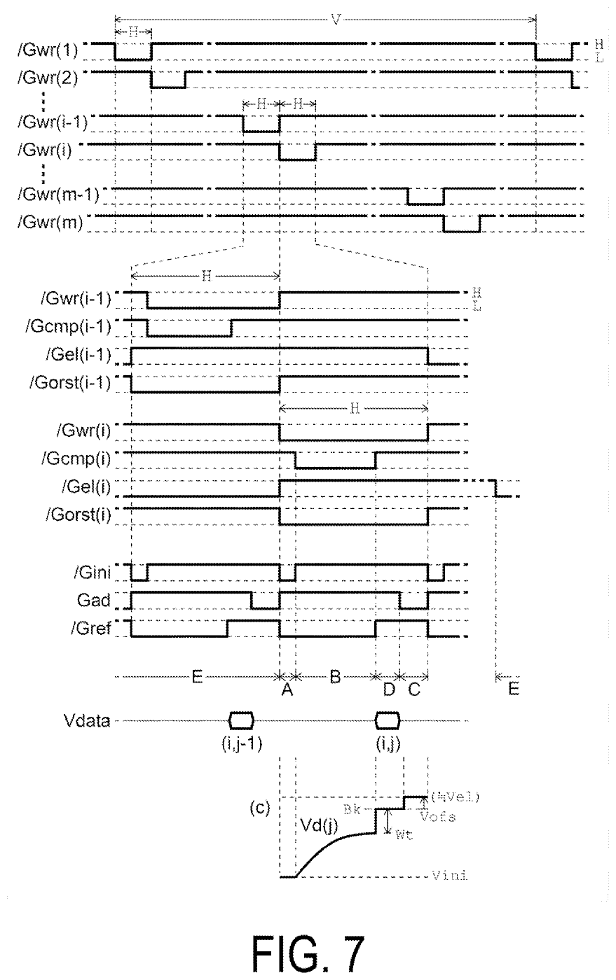

FIG. 7 is a timing chart for illustrating an operation of the electro-optical device 10 according to the second embodiment. In the second embodiment, as illustrated in the drawing, the temporal sequence between the offset period (C) and the writing period (D) is switched from the first embodiment (see FIG. 4).

Specifically, in the second embodiment, the writing period (D) is performed after the compensation period (B).

Thus, in the horizontal scanning period (H) for the i-th row, the potential Vd(j) of the data line in the j-th column is changed from the threshold equivalent voltage at the final stage of the compensation period (B) to the potential corresponding to the gradation level (the potential within the range from Bk to Wt) in the writing period (D), and then is offset and elevated by the potential change amount Vofs in the offset period (C).

Note that the only difference between the potential change in the offset period (C) and the potential change in the writing period (D) is the temporal sequence. Thus, the potential of the gate node g at the time of termination of the horizontal scanning period (H) is the same as that in the first embodiment.

Thus, in the second embodiment, as in the first embodiment, the narrow pitch can easily be achieved, and the increase in chip size can be avoided.

In the first embodiment or the second embodiment, the capacitance element 59, the DA conversion circuit 500, and the like are provided corresponding to the data line 14 in each of the columns. Thus, as the pitch of the data lines 14 gets narrower, it becomes more difficult to arrange the capacitance element 59, the DA conversion circuit 500, and the like in each column in the semiconductor substrate. But when arrangement of the capacitance element 59, the DA conversion circuit 500, and the like is devised, this in turn causes the parasitic capacitances of the data lines 14 to differ for each column, leading to degradation in display quality. In view of this, description is made on a third embodiment in which degradation in display quality is suppressed even when the parasitic capacitances of the data lines 14 differ for each column.

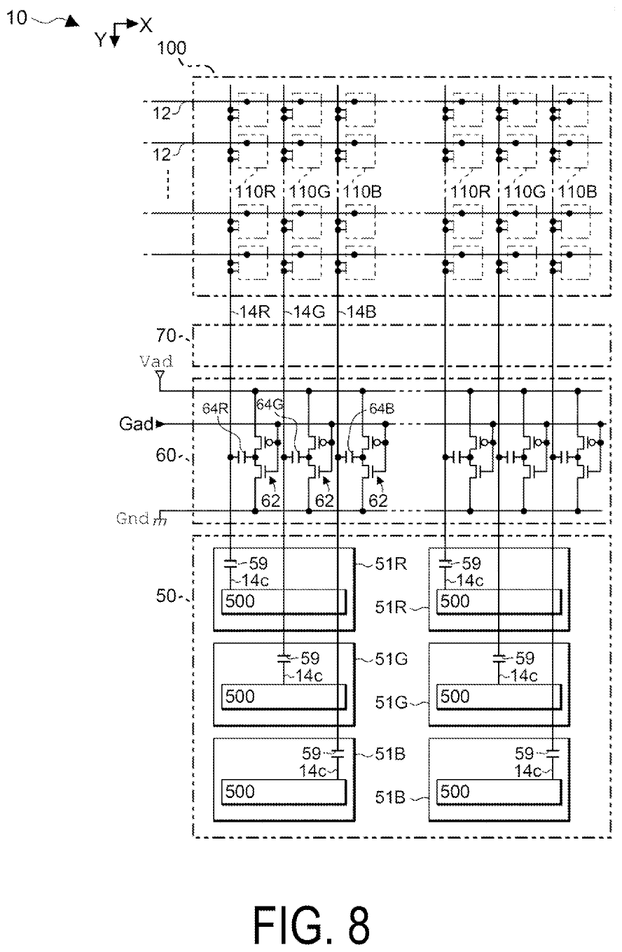

FIG. 8 is a diagram illustrating an electrical configuration of the electro-optical device 10 according to the third embodiment, together with arrangement of the respective elements.

In the third embodiment, in the display region 100, pixel circuits 110R, 110G, and 110B are provided in the following manner, corresponding to the scanning lines 12 in the m rows and the data line 14R, 14G, and 14B in the n columns. Specifically, the red pixel circuit 110R is provided corresponding to an intersection between the scanning line 12 in the i-th row and the data line 14R in the (j−2)-th column. The green pixel circuit 110G is provided corresponding to an intersection between the scanning line 12 in the i-th row and the data line 14G in the (j−1)-th column. The blue pixel circuit 110B is provided corresponding to an intersection between the scanning line 12 in the i-th row and the data line 14B in the j-th column.

The pixel circuit 110R includes the OLED 130 that emits light containing a red color component, the pixel circuit 110G includes the OLED 130 that emits light containing a green color component, and the pixel circuit 110B includes the OLED 130 that emits light containing a blue color component. One color pixel is expressed by additive color mixing of the light emitted from the pixel circuits 110R and 110G and the pixel circuit 110B that are adjacent to each other in the same row. Therefore, in the present embodiment, in terms of a color pixel, an image is displayed in the matrix arrangement of the vertical m rows and the horizontal (n/3) columns.

In the third embodiment, the data signal output circuit 50 is illustrated in a simplified manner as a circuit group 51R corresponding to the data line 14R, a circuit group 51G corresponding to the data line 14G, and a circuit group 51B corresponding to the data line 14B.

Specifically, each of the circuit groups 51R, 51G, and 51B is a group collectively including the selection circuit 520, the first latch circuit L1, the second latch circuit L2, the DA conversion circuit 500, the transistor 58, the data signal output line 14c, and the capacitance element 59. Note that in FIG. 8, only the DA conversion circuit 500, the data signal output line 14c, and the capacitance element 59 are illustrated, and the other elements are omitted.

In the third embodiment, the circuit groups 51R, 51G, and 51B are arranged in the Y direction in the stated order, and are arranged in the X direction in the three columns corresponding to the data lines 14R, 14G, and 14B. In a case of such arrangement, in plan view, the data line 14G passes through the circuit group 51R, and the data line 14B passes through the circuit groups 51R and 51G. Thus, in the third embodiment, the lengths of the data lines 14R, 14G, and 14B are reduced in the stated order. When the lengths of the data lines 14R, 14G, and 14B differ, the parasitic capacitance values of the data lines 14R, 14G, and 14B differ. Specifically, the parasitic capacitances pf the data lines 14R, 14G, and 14B establish a relationship of 14R<14G<14B.

As described above, the potential change amount Vofs of the gate node g in the offset period is a value obtained by multiplying the potential change amount at one end of the capacitance element 64 by the ratio of the capacitance value of the capacitance element 64 to the “composite capacitance value”.

In the third embodiment, the parasitic capacitance values of the data lines 14R, 14G, and 14B differ. Thus, unless some countermeasures are taken, the potential change amount Vofs differs for each of the data lines 14R, 14G, and 14B. As a result, color shift is caused, and degradation in display quality is inevitable.

In view of this, in the third embodiment, the capacitance value of the capacitance element 64 of the offset circuit 60 differs for each of the data lines 14R, 14G, and 14B. Specifically, among the capacitance elements 64 of the offset circuit 60, a capacitance element corresponding to the data line 14R is a capacitance element 64R, a capacitance element corresponding to the data line 14G is a capacitance element 64G, and a capacitance element corresponding to the data line 14B is a capacitance element 64B. Further, the capacitance values of the capacitance elements 64R, 64G, and 64B establish the following relationship. Specifically, a relationship of 64R<64G<64B is established.

The potential change amount Vofs of the gate node g in the offset period is a value obtained by multiplying the potential change amount at one end of the capacitance element 64R/64G/64B by the ratio of a capacitance value of the capacitance element 64 to the “composite capacitance value”.

In the third embodiment, as the parasitic capacitance values of the data lines 14R/14G/14B are increased in order, the capacitance values of the capacitance element 64R/64G/64B are also increased in order. Thus, the ratio can be equalized in the data lines 14R, 14G, and 14B. Thus, in the third embodiment, the potential change amount Vofs in each of the columns can be equalized.

In this manner, according to the third embodiment, even when the parasitic capacitances of the data lines 14R, 14G, and 14B are different from each other, the potential change amount Vofs can be equalized in the data lines 14R, 14G, and 14B. Thus, in the third embodiment, color shift can be suppressed, and degradation in display quality can be suppressed.

In the third embodiment, when the parasitic capacitances of the data lines 14R, 14G, and 14B differ, there is adopted a method of obtaining different capacitance values of the capacitance elements 64R, 64G, and 64B to equalize the potential change amount Vofs in each of the columns in the offset period (C). However, a method other than that may be used to equalize the potential change amount Vofs in each of the columns.

In view of this, description is made on a fourth embodiment in which the potential change amount Vofs in each of the columns is equalized by a method different from that in the third embodiment even when the parasitic capacitance of the data line 14 differs for each column.

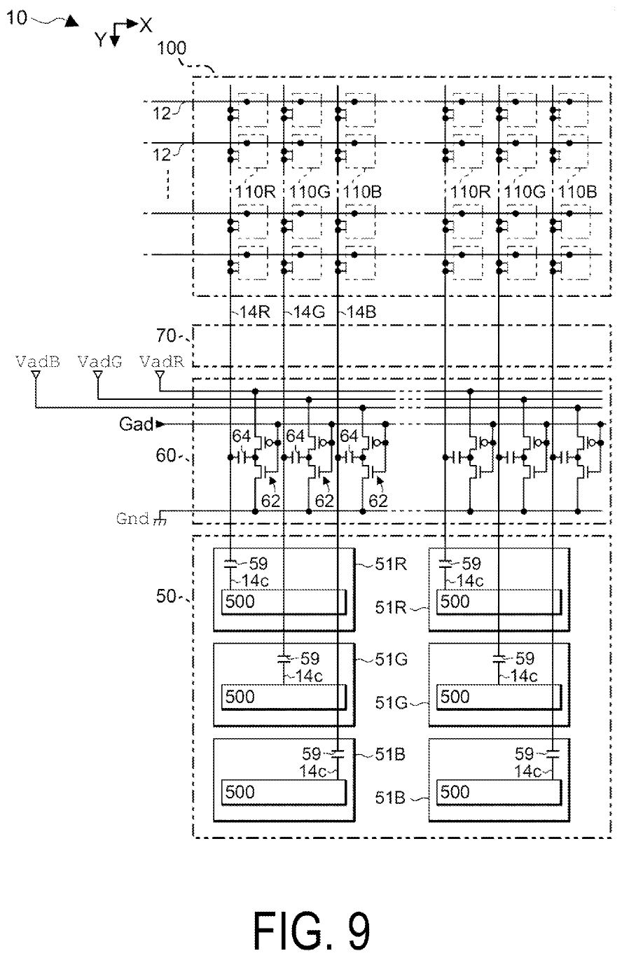

FIG. 9 is a diagram illustrating an electrical configuration of the electro-optical device 10 according to the fourth embodiment, together with arrangement of the respective elements.

The commonly shared points and differences between the fourth embodiment and the third embodiment are as follows.

In other words, the fourth embodiment is common with the third embodiment in that the parasitic capacitances of the data lines the data lines 14R, 14G, and 14B establish the relationship of 14R<14G<14B. However, the fourth embodiment is different from the third embodiment in that, firstly, the capacitance values of the capacitance elements 64 of the offset circuit 60 are the same, and secondly, the power potentials of the NOT circuits 62 of the offset circuit 60 differ for each column.

In the offset circuit 60 according to the fourth embodiment, a high-level potential of the power supply voltage of the NOT circuit 62 corresponding to the data line 14R is the potential VadR, a high-level of the power supply voltage of the NOT circuit 62 corresponding to the data line 14G is the potential VadG, and a high-level of the power supply voltage of the NOT circuit 62 corresponding to the data line 14B is the potential VadB.

In the fourth embodiment, as in the third embodiment, when the parasitic capacitance of the data line 14R, the parasitic capacitance of the data line 14G, and the parasitic capacitance of the data line 14B also establish the relationship 14R<14G<14B, the potentials VadR, VadG, and VadB establish the following relationship. Specifically, a relationship VadR<VadG<VadB is established.

The potential change amount Vofs of the gate node g in the offset period is a value obtained by multiplying a potential change amount at one end of the capacitance element 64 by a ratio of a capacitance value of the capacitance element 64 to the “composite capacitance value”. The potential change amount at one end of the capacitance element 64 (the shift amount of the potential of the other electrode) is equivalent to the power supply voltage of the NOT circuit 62. As the parasitic capacitance value of the data line 14R, 14G, or 14B is increased, the ratio is reduced. However, in the fourth embodiment, the potential change amount at one end of the capacitance element 64 is increased, and hence the potential change amount Vofs in each of the columns can be equalized.

In this manner, according to the fourth embodiment, even when the parasitic capacitances of the data lines 14R, 14G, and 14B are different from each other, the potential change amount Vofs can be equalized in the data lines 14R, 14G, and 14B. Thus, in the fourth embodiment, as in the third embodiment, color shift can be suppressed, and degradation in display quality can be suppressed.

In the electro-optical device 10 according to the first to fourth embodiments, there is adopted a configuration in which, with the display region 100 as a reference, the data signal output circuit 50, the offset circuit 60, and the initialization circuit 70 are arranged in the stated order in a direction opposite to the Y direction. However, the configuration is not limited thereto. In view of this, description is made on the fifth embodiment obtained by changing a position of the offset circuit 60.

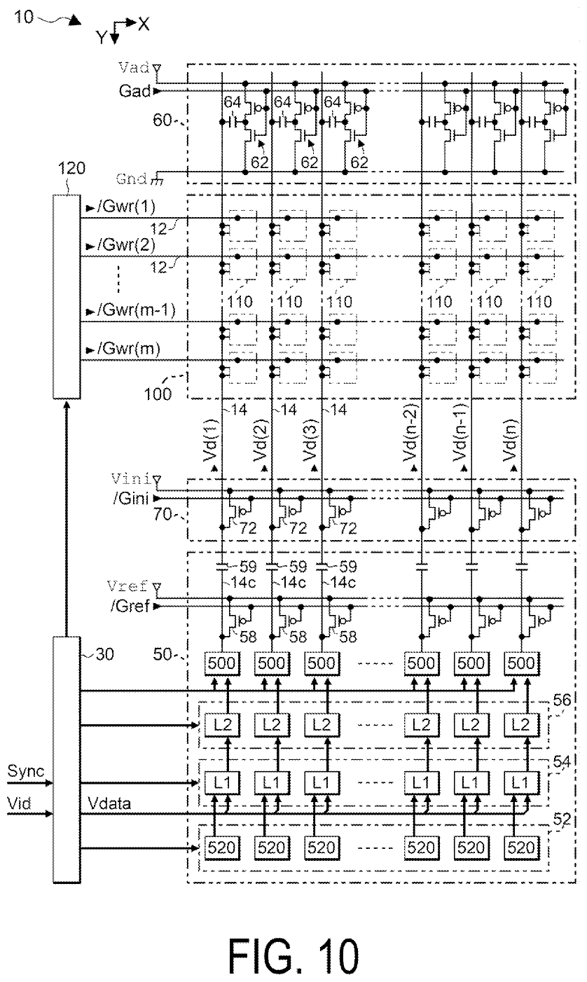

FIG. 10 is a block diagram illustrating an electrical configuration of the electro-optical device 10 according to the fifth embodiment. In the electro-optical device 10 according to the fifth embodiment, with the display region 100 as a reference, the offset circuit 60 is arranged on the opposite side of the data signal output circuit 50 and the initialization circuit 70. With this configuration, the width of the region in the Y direction with respect to the display region 100 in the region outside the display region 100 in the semiconductor substrate, in other words, the length in the Y direction in the region in which the data signal output circuit 50 and the like are provided can be reduced.

Note that in the fifth embodiment, there is adopted a configuration in which the offset circuit 60 is arranged on the opposite side of the data signal output circuit 50 and the initialization circuit 70 with the display region 100 as a reference. A configuration in which the initialization circuit 70 and the offset circuit 60 are also arranged on the opposite side of the data signal output circuit 50 with the display region 100 as a reference may be adopted. With this configuration, the length in the Y direction in the region in which the data signal output circuit 50 and the like are provided can further be reduced.

In the electro-optical device 10 according to any one of the first embodiment to the fifth embodiment, there is adopted a configuration in which one pixel circuit 110 includes the transistors 121 to 125, specifically, a so-called 5Tr configuration. In a configuration in which one pixel circuit 110 includes a large number of transistors, there are difficulties in miniaturization. Further, this may cause the decrease in yield. In view of this, description is made on a sixth embodiment obtained by reducing the number of transistors in one pixel circuit 110.

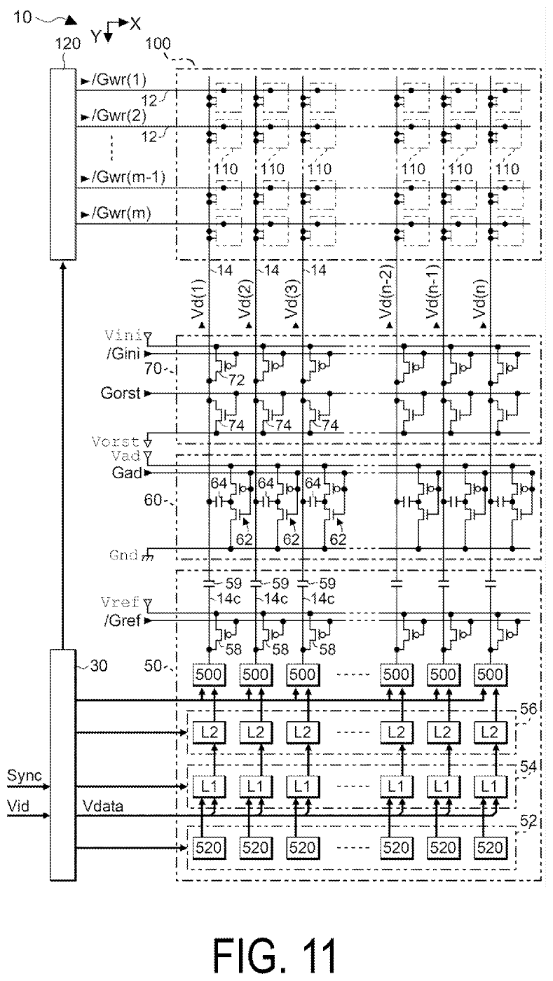

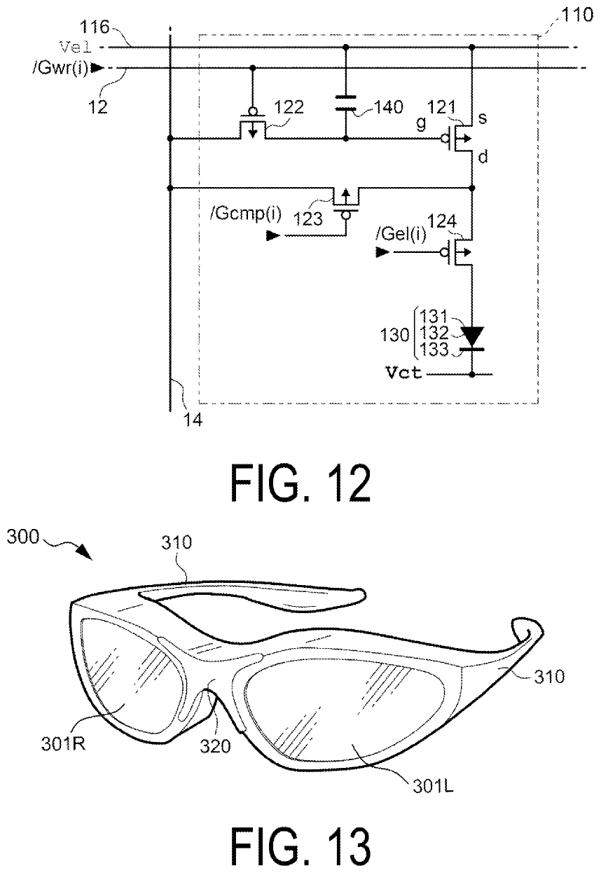

FIG. 11 is a block diagram illustrating an electrical configuration of the electro-optical device 10 according to the sixth embodiment, and FIG. 12 is a diagram illustrating the pixel circuit 110 in the electro-optical device 10.

As illustrated in FIG. 12, in the sixth embodiment, there is adopted a configuration in which one pixel circuit 110 includes the transistors 121 to 124, specifically, a so-called 4Tr configuration. The transistor 125 of the pixel circuit 110 in the first embodiment (see FIG. 3) is not present.

As illustrated in FIG. 11, in the initialization circuit 70, a transistor 74 is provided for each column in place of the transistor 125. The transistor 74 is an n-type, for example. The control signal Gorst is supplied commonly to a gate node of the transistor 74 in each of the columns. A source node of the transistor 74 in the j-th column is coupled to a power supplying line at the potential Vorst, and a drain node of the transistor 74 in the j-th column is coupled to the data line 14 in the j-th column.

In the sixth embodiment, although not explicitly illustrated, the initialization period (A) is divided into (A1) and (A2), for example.

In the initialization period (A1), the control signal /Gini and the control signal Gorst are at the H level. Therefore, in each of the columns, the transistor 72 is in the off state, and the transistor 74 is in the on state. Thus, the data line 14 in each of the columns is at the potential Vorst.

Meanwhile, in the initialization period (A1) for the i-th row, in a state in which the scanning signal /Gwr(i) is at the H level, the control signals /Gcmp(i) and /Gel(i) are at the L level. Thus, in the pixel circuit 110 in the i-th row, the transistor 122 is in the off state< and the transistors 123 and 124 are in the on state. Therefore, in the pixel circuit 110 in the i-th row, the pixel electrode 131 being the anode of the OLED 130 is grounded to the potential Gnd via the data line 14, and the transistors 123 and 124 in order. Thus, the OLED 130 is turned off, and the pixel electrode 131 is reset to the potential Vorst.

In the initialization period (A2), the control signal /Gini and the control signal Gorst are at the L level. Therefore, in each of the columns, the transistor 72 is changed to the on state, and the transistor 74 is changed to the off state. Thus, the data line 14 in each of the columns is at the potential Vini.

Meanwhile, in the initialization period (A1) for the i-th row, the scanning signal /Gwr(i) is changed to the L level, and the control signals /Gcmp(i) and /Gel(i) are at the H level. Thus, in the pixel circuit 110 in the i-th row, the transistor 122 is changed to the on state, and the transistors 123 and 124 are changed to the off state. Therefore, in the pixel circuit 110 in the i-th row, as in the initialization period (A) in the first embodiment, the potential Vini of the data line 14 arrives at the gate node g of the transistor 121 via the transistor 122 in the on state.

In the sixth embodiment, the operation after the compensation period (B) is similar to that in the first embodiment or the second embodiment.

In the electro-optical device 10 according to the sixth embodiment, one pixel circuit 110 includes the transistors 121 to 124. Thus, as compared to the first embodiment, miniaturization is easily achieved, and the degrease in yield can be suppressed.

In the first embodiment to the sixth embodiment described above (hereinafter referred to as “embodiments and the like”), various modifications or applications are possible as described below.

In the embodiments and the like, description is made with the OLED 130 given as one example of the light-emitting element. However, other light-emitting elements may be used. For example, an LED may be used as the light-emitting element, or a liquid crystal element also using an illumination mechanism may be used. In other words, the light-emitting element may be an electro-optical element that is in an optical state corresponding to the voltage of the data line 14.

In the embodiments and the like, an example of 10-bit conversion is illustrated as the DA conversion circuit 500. However, the DA conversion circuit 500 is not limited thereto.

In the embodiments and the like, there is adopted a configuration in which the threshold voltage of the transistor 121 of the pixel circuit 110 is compensated. However, a configuration in which the threshold voltage is not compensated, specifically, a configuration in which the transistor 123 is omitted may be adopted.

Further, a configuration in which the light-emission period (E) is not controlled, specifically, a configuration in which the transistor 124 is omitted may be adopted.

The channel types of the transistors 121 to 125 and the like are not limited to those in the embodiments and the like. Further, the transistors 121 to 125 and the like may be replaced with transmission gates as appropriate.

Next, an electronic apparatus to which the electro-optical device 10 according to the above-described embodiments is applied is described. The electro-optical device 10 is suitable for application with a small pixel and high definition display. Therefore, a head-mounted display is described as an example of the electronic apparatus.

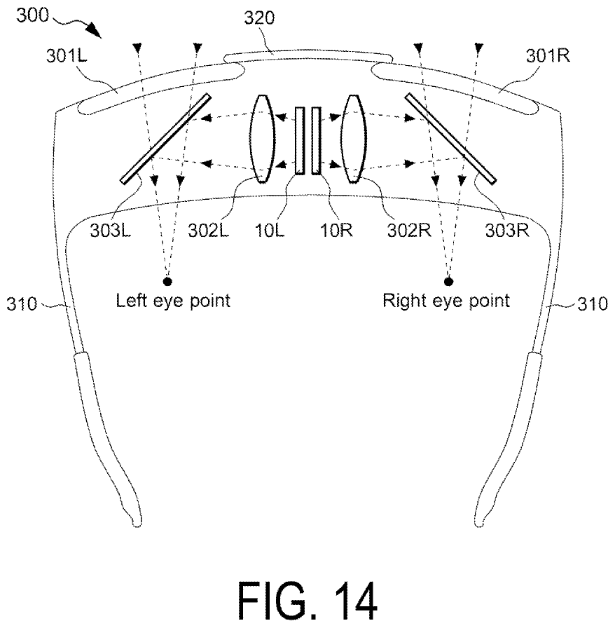

FIG. 13 is a view illustrating an exterior of a head-mounted display, and FIG. 14 is a view illustrating an optical configuration thereof.

First, as illustrated in FIG. 13, a head-mounted display 300 includes, in terms of exterior, temples 310, a bridge 320, and lenses 301L and 301R, similar to typical eyeglasses. In addition, as illustrated in FIG. 14, in the head-mounted display 300, an electro-optical device 10L for a left eye and an electro-optical device 10R for a right eye are provided in the vicinity of the bridge 320 and on the back side (the lower side in the drawing) of the lenses 301L and 301R.

An image display surface of the electro-optical device 10L is arranged to be on the left side in FIG. 14. Thus, a display image by the electro-optical device 10L is output via an optical lens 302L in a 9-o'clock direction in the drawing. A half mirror 303L reflects the display image by the electro-optical device 10L in a 6-o'clock direction, while the half mirror 303L transmits light incident in a 12-o'clock direction. An image display surface of the electro-optical device 10R is arranged on the right side opposite to the electro-optical device 10L. Thus, the display image by the electro-optical device 10R is output via the optical lens 302R in a 3-o'clock direction in the drawing. A half mirror 303R reflects the display image by the electro-optical device 10R in a 6-o'clock direction, while the half the mirror 303R transmits light incident in a 12-o'clock direction.

In this configuration, a wearer of the head-mounted display 300 can observe the display images by the electro-optical devices 10L and 10R in a see-through state in which the display images by the electro-optical devices 10L and 10R overlap the outside.

In addition, in the head-mounted display 300, in the images for both eyes with parallax, an image for a left eye is displayed on the electro-optical device 10L, and an image for a right eye is displayed on the electro-optical device 10R, and thus, it is possible to cause the wearer to sense the displayed images as an image displayed having a depth or a three-dimensional effect.

Note that in addition to the head-mounted display 300, the electric apparatus including the electro-optical device 10 can be applied to an electronic viewing finder in a video camera, a lens-exchangeable digital camera, or the like, a mobile information terminal, a wristwatch display, a light valve for a projection type projector, and the like.

For example, the following aspects of the present disclosure are understood from the embodiments illustrated above.

An electro-optical device according to one aspect (first aspect) includes a scanning line, a first data line, a first pixel circuit provided corresponding to an intersection between the scanning line and the first data line and including a first light-emitting element configured to emit light at brightness corresponding to a potential of the first data line, an output circuit configured to output, to a first output line, a first data signal at a potential corresponding to the brightness of the first light-emitting element, a first coupling capacitor including two electrodes of which one electrode is electrically coupled to the first output line and the other electrode is electrically coupled to the first data line, and a shift circuit configured to shift a potential of the first data line before the first data signal is output or after the first data signal is output.

According to the first aspect, the potential of the data line can be shifted (offset) without increasing the capacitance value of the first coupling capacitor. Thus, miniaturization easily achieved. Note that with a configuration in which the potential of the other electrode of the first capacitance element is shifted after the first data signal is output, the potential of the data line is stabilized. Thus, display quality can be improved.

Note that the OLED 130 is one example of the first light-emitting element, the data signal output line 14c is one example of the first output line, and the DA conversion circuit 500 is one example of the output circuit. The capacitance element 59 is one example of the first coupling capacitor, the one end of the capacitance element 59 is one example of the one electrode of the first coupling capacitor, and the other end of the capacitance element 59 is one example of the other electrode of the first coupling capacitor. The capacitance element 64 is one example of the first capacitance element, the one end of the capacitance element 64 is one example of the other electrode of the first capacitance element, and the other end of the capacitance element 64 is one example of the one electrode of the first capacitance element. The NOT circuit 62 is one example of the shift circuit.

An electro-optical device according to a second aspect being a specific aspect of the first aspect includes a second data line, a second pixel circuit provided corresponding to an intersection between the scanning line and the second data line and including a second light-emitting element configured to emit light at brightness corresponding to a potential of the second data line, a second coupling capacitor including two electrodes of which one electrode is electrically coupled to a second output line and the other electrode is electrically coupled to the second data line, a first capacitance element including two electrodes of which one electrode is electrically coupled to the first data line, and a second capacitance element including two electrodes of which one electrode is electrically coupled to the second data line, wherein the output circuit outputs, to the second output line, a second data signal at a potential corresponding to the brightness of the second light-emitting element, the shift circuit shifts the potential of the first data line by shifting a potential of the other electrode of the first capacitance element and shifts the potential of the first data line by shifting a potential of the other electrode of the second capacitance element, before the second data signal is output or after the second data signal is output, and a capacitance value of the first capacitance element and a capacitance value of the second capacitance element are different from each other.

According to the second aspect, even when the parasitic capacitance of the first data line and the parasitic capacitance of the second data line are different from each other, the potential after shifting can be equalized. Thus, display quality can be improved.

Note that the data line 14G is one example of the second data line, the data signal output line 14c corresponding to the data line 14G is one example of the second output line. The OLED 130 of the pixel circuit 110R is one example of the first light-emitting element, and the OLED 130 of the pixel circuit 110G is one example of the second light-emitting element. The capacitance element 59R is one example of the first coupling capacitor, the capacitance element 59G is one example of the second coupling capacitor, the capacitance element 64R is one example of the first capacitance element, and the capacitance element 64G is one example of the second capacitance element.

An electro-optical device according to a third aspect being a specific aspect of the first aspect further includes a second data line, a second pixel circuit provided corresponding to an intersection between the scanning line and the second data line and including a second light-emitting element configured to emit light at brightness corresponding to a potential of the second data line, a second coupling capacitor including two electrodes of which one electrode is electrically coupled to a second output line and the other electrode is electrically coupled to the second data line, a first capacitance element including two electrodes of which one electrode is electrically coupled to the first data line, and a second capacitance element including two electrodes of which one electrode is electrically coupled to the second data line, wherein the output circuit outputs, to the second output line, a second data signal at a potential corresponding to the brightness of the second light-emitting element, the shift circuit shifts the potential of the first data line by shifting a potential of the other electrode of the first capacitance element and shifts the potential of the first data line by shifting a potential of the other electrode of the second capacitance element, before the second data signal is output or after the second data signal is output, and a shift amount of the potential of the other electrode of the first capacitance element and a shift amount of the potential of the other electrode of the second capacitance element are different from each other.

According to the third aspect, even when the parasitic capacitance of the first data line and the parasitic capacitance of the second data line are different from each other, the potential after shifting can be equalized. Thus, display quality can be improved.

In an electro-optical device according to a fourth aspect being a specific aspect of the first aspect, the first pixel circuit is arranged between the first coupling capacitor and the output circuit, and the first capacitance element and the shift circuit. According to the fourth aspect, it is possible to improve a situation where a region outside the region in which the pixel circuits are arrayed (display region) becomes uneven and wider.

An electronic apparatus according to a fifth aspect includes the electro-optical device according to any one of the first to fourth aspects.

What is claimed is:

1. An electro-optical device comprising:
a scanning line;
a first data line;
a first pixel circuit provided corresponding to an intersection between the scanning line and the first data line and including a first light-emitting element configured to emit light at brightness corresponding to a potential of the first data line;
an output circuit configured to output, to a first output line, a first data signal at a potential corresponding to the brightness of the first light-emitting element;
a first coupling capacitor including two electrodes of which one electrode is electrically coupled to the first output line and the other electrode is electrically coupled to the first data line; and
a shift circuit configured to shift a potential of the first data line before the first data signal is output or after the first data signal is output.

2. The electro-optical device according to claim 1, further comprising:
a second data line;
a second pixel circuit provided corresponding to an intersection between the scanning line and the second data line and including a second light-emitting element configured to emit light at brightness corresponding to a potential of the second data line;
a second coupling capacitor including two electrodes of which one electrode is electrically coupled to a second output line and the other electrode is electrically coupled to the second data line;
a first capacitance element including two electrodes of which one electrode is electrically coupled to the first data line; and
a second capacitance element including two electrodes of which one electrode is electrically coupled to the second data line, wherein
the output circuit outputs, to the second output line, a second data signal at a potential corresponding to the brightness of the second light-emitting element,
the shift circuit shifts the potential of the first data line by shifting a potential of the other electrode of the first capacitance element and shifts the potential of the first data line by shifting a potential of the other electrode of the second capacitance element, before the second data signal is output or after the second data signal is output, and
a capacitance value of the first capacitance element and a capacitance value of the second capacitance element are different from each other.

3. The electro-optical device according to claim 1, further comprising:
a second data line;
a second pixel circuit provided corresponding to an intersection between the scanning line and the second data line and including a second light-emitting element configured to emit light at brightness corresponding to a potential of the second data line;
a second coupling capacitor including two electrodes of which one electrode is electrically coupled to a second output line and the other electrode is electrically coupled to the second data line;
a first capacitance element including two electrodes of which one electrode is electrically coupled to the first data line; and
a second capacitance element including two electrodes of which one electrode is electrically coupled to the second data line, wherein
the output circuit outputs, to the second output line, a second data signal at a potential corresponding to the brightness of the second light-emitting element,
the shift circuit shifts the potential of the first data line by shifting a potential of the other electrode of the first capacitance element and shifts the potential of the first data line by shifting a potential of the other electrode of the second capacitance element, before the second data signal is output or after the second data signal is output, and
a shift amount of the potential of the other electrode of the first capacitance element and a shift amount of the potential of the other electrode of the second capacitance element are different from each other.

4. The electro-optical device according to claim 1, wherein
the first pixel circuit is arranged between the first coupling capacitor and the output circuit, and the first capacitance element and the shift circuit.

5. An electronic apparatus comprising the electro-optical device according to claim 1.
